(19) United States
(12) Patent Application Publication
(10) Pub. No.: US 2009/0286104 A1
(43) Pub. Date: Nov. 19, 2009

(54) MULTI-LAYERED NICKEL-PHOSPHOROUS COATINGS AND PROCESSES FOR FORMING THE SAME

(75) Inventors: Steven Alfred Tysoe, Ballston Spa, NY (US); Eugenio Giorni, Firenze (IT); Dennis Michael Gray, Delanson, NY (US); Lawrence Bernard Kool, Clifton Park, NY (US); Francesco Sorbo, Firenze (IT)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: General Electric Company, Schenectady, NY (US)

(21) Appl. No.: 12/122,060

(22) Filed: May 16, 2008

(51) Int. Cl. B32B 15/18; B05D 1/18

(52) U.S. Cl. 428/634; 427/438; 428/679

(57) ABSTRACT

Multiple layers of nickel phosphorous coatings are formed by electroless plating onto a base metal substrate such as a turbine component. In one embodiment, a first nickel layer metallurgical bonded by a heat treatment process to a surface of the base metal substrate, the first nickel layer containing about 4 to about 6 weight percent phosphorous with the balance being essentially nickel; and a second nickel layer deposited onto the first layer, the second nickel layer containing about 8 to about 12 weight percent phosphorous with the balance being essentially nickel, wherein the first and second layers are formed by electroless plating. In this manner, adhesion is maximized without degrading the properties of the second layer such as corrosion resistance and ductility. Also disclosed are processes for forming the multilayered nickel phosphorus coatings.

### BACKGROUND

The present disclosure generally relates to a multi-layered nickel phosphorous coating formed by electroless plating.

Electroless plating is an auto-catalytic reaction that can be used to deposit a coating of a metal on a substrate. Unlike electroplating, it is not necessary to pass an electric current through the solution to form a deposit. This plating technique is generally employed to prevent corrosion and wear. Electroless nickel plating has several advantages versus electroplating. Free from flux-density and power supply issues, it provides an even deposit regardless of workpiece geometry, and with the proper pre-plate catalyst, can deposit on non-conductive surfaces.

Electroless nickel plating, employing phosphorus reducing agents such as hypophosphites, is an established plating method that provides a continuous deposit of a nickel phosphorus alloy coating on metallic or non metallic substrates without the need for an external electric plating current. It is simply achieved by immersion of the desired substrate into an aqueous nickel-plating bath solution in the presence of a phosphorus containing reducing agent and under appropriate electroless nickel plating conditions.

Phosphorus containing electroless nickel alloys, produced in the electroless nickel plating, are valuable industrial coating deposits having desirable properties such as corrosion resistance and hardness. They are conventionally made in the electroless nickel-plating reaction, which produces the alloy as a deposit on a suitable substrate. However, prior work involves the deposition of only a single layer and attempts to optimize the single layer for corrosion, ductility and adhesion have not been successful. For example, a heat treatment process is often applied to form a metallurgical bond between the electroless nickel phosphorus coating and the base metal substrate so as to maximize adhesion. However, as a result of heat treatment, other qualities such as hardness, corrosion resistance, wear resistance, ductility and stress, fatigue properties, magnetic properties, can be deleteriously affected.

Accordingly, there is a need for improved processes and coatings that maximize corrosion resistance, ductility, and adhesive properties.

### BRIEF SUMMARY

Disclosed herein are processes for forming a multilayered coating on a base metal substrate. In one embodiment, the process is an electroless plating process comprising contacting a base metal substrate with a first plating bath comprising a source of nickel cations and a phosphorous containing reducing agent in amounts effective to form a first layer comprising about 4 to about 6 weight percent phosphorous with the balance being essentially nickel; heating the first layer and the base metal substrate to a temperature greater than 500° C. to metallurgically bond the first layer to the base metal substrate; and contacting the first layer with a second plating bath comprising a source of nickel cations and a phosphorous containing reducing agent in amounts effective to form a second layer comprising about 8 to about 12 weight percent phosphorous with the balance being essentially nickel.

A turbine component comprises a first nickel layer metallurgical bonded to a surface of the turbine component, the first nickel layer containing about 4 to about 6 weight percent phosphorous with the balance being essentially nickel; and a second nickel layer deposited onto the first layer, the second nickel layer containing about 8 to about 12 weight percent phosphorous with the balance being essentially nickel, wherein the first and second layers are formed by electroless plating.

A carbon or low alloy steel substrate comprises a first nickel layer metallurgical bonded to a surface of the turbine component, the first nickel layer containing about 4 to about 6 weight percent phosphorous with the balance being essentially nickel; and a second nickel layer deposited onto the first layer, the second nickel layer containing about 8 to about 12 weight percent phosphorous with the balance being essentially nickel, wherein the first and second layers are formed by electroless plating.

The disclosure may be understood more readily by reference to the following detailed description of the various features of the disclosure and the examples included therein.

### DETAILED DESCRIPTION

Disclosed herein is a multi-layered nickel phosphorous coating that maximizes adhesion, as well as other properties such as hardness, corrosion resistance, wear resistance, ductility and stress, fatigue properties, magnetic properties, and the like. Also disclosed herein are processes for forming the multi-layered nickel phosphorous coating onto a base metal substrate such as a turbine component. The multi-layered nickel phosphorous coating generally includes a first nickel phosphorous layer containing about 4 to about 6 weight percent phosphorous with the balance being essentially nickel that is metallurgically bonded to the base metal substrate through a heat treatment process. A second nickel phosphorous layer is deposited onto the first nickel phosphorous layer after surface activation. The second nickel phosphorous layer contains about 8 to about 12 percent by weight phosphorous with the balance being essentially nickel. Additional nickel phosphorous layers can be added as may be desired for some applications. The additional layer can be in addition to the first and second layers and/or intermediate thereto. The process for forming the layers includes an electroless nickel deposition process.

The electroless nickel deposition process for forming the multi-layered coating generally includes immersing the base metal substrate into multiple electroless plating solution. The electroless plating solutions include a nickel source, and at least one phosphorous containing reducing agent as will be described below. Optionally, the plating solutions, i.e., baths, may further contain buffering agents, complexing agents, stabilizers, brighteners, and like additives commonly employed in electroless plating solutions.

Prior to electroless plating, the surface of the base metal substrate may first be treated so as to roughen the surface and increase the available surface area. In this manner, adhesion can be improved. The base metal substrate is then immersed into a first plating bath containing the source of nickel cations, and at least one phosphorous containing reducing agent. The composition of the bath and operating conditions are selected so as to provide a layer containing about 4 to about 6 weight percent phosphorous with the balance being essentially nickel. The coated substrate is then subjected to a heat treatment process to promote the formation of a metallurgical bond between the first layer and the base metal substrate, thus maximizing adhesion.

The heat treatment process generally includes subjecting the coated substrate to temperatures greater than about 500° C. for 30 minutes to several hours. In one embodiment, the temperature range is from 550 to 700° C. and the heat treatment time is in the range of one hour to 60 hours. As was discussed in the background, the heat treatment may change the mechanical properties of the coating. This is due to precipitation of nickel phosphide, which can occur during the heat treatment process. However, by maintaining a relatively low level of phosphorous in the coating, the amount of nickel phosphide precipitation is minimized while maximizing the adhesion. In one embodiment, heat treatment can be carried out in an inert atmosphere such as one of argon or nitrogen, in order to minimize oxidation.

The first layer is then treated to render the surface active. Surface activation of the first layer generally includes treatment with 30% by volume of concentrated hydrochloric acid (37% by weight) in water at 20° C. for five minutes. Alternatively, the activation solution can contain 33 g/L ammonium bifluoride (5-50 g/L). It should be apparent to one of skill in the art that the treatment is not limited to HCl and could be accomplished with other mineral acids such as nitric acid, phosphoric acid, ferric chloride etc.

The thus treated substrate with the coated first nickel phosphorous layer is then immersed into a second plating bath containing the source of nickel cations, and at least one phosphorous containing reducing agent. The composition of the bath and operating conditions are selected so as to provide a layer containing about 8 to about 12 weight percent phosphorous with the balance being essentially nickel. The layer is not heat treated such that the resulting multilayered structure exhibits maximum adhesion without degradation of the second layer. As such, the beneficial properties of hardness, corrosion resistance, wear resistance, ductility and stress, fatigue properties, magnetic properties, and the like, of the second nickel phosphorous layer are maximized whereas the entire structure exhibits the benefits of being heat treated so as to maximize adhesion to the base metal substrate.

The thicknesses of the first and second layers are not intended to be limited. Exemplary thicknesses are, for example, 0.0005-0.005 inches in for the first layer and 0.002-0.010 inches for the second layer.

The nickel source generally includes any of the water soluble or semi-soluble salts of nickel, which are conventionally employed. Suitable sources of the nickel cations are the salts of nickel including, but not limited to, sulfates, chloride, sulfamates, acetates, mixtures thereof or other nickel salts having anions compatible with the electroless system. A particularly convenient source of the nickel cation is nickel hypophosphite. Employment of such nickel source additionally provides the hypophosphite reducing agent and allows the use of only one source of two plating bath components instead of two separate sources of the nickel and hypophosphite reducing agent. The concentrations of the nickel cations maintained within the bath may be varied but generally sufficient sources of the nickel cations are within certain preferred ranges. For example, the source of nickel cations should be added to the bath sufficient to provide a concentration of nickel cations within the range of from 0.05 to 0.2 M mols per liter.

Suitable phosphorus-containing compounds may include hypophosphites or hypophosphorous acid. The hypophosphite reducing agent employed in the baths may be any of those conventionally used for electroless nickel-plating. For example, suitable hypophosphites include those of ammonium, lithium, sodium, potassium, magnesium, calcium, strontium, and mixtures thereof. The amount of the reducing agent employed in the plating bath is at least sufficient to stoichiometrically reduce the nickel cations in the electroless reaction to free metals and such concentration is usually within the range of from about 10 grams per liter (g/L) to about 50 g/L. For the first plating solution, the phosphorous reducing agent concentration is usually within the range of from about 10 g/L about 50 g/L whereas in the second plating bath the phosphorous reducing agent concentration is usually within the range of from about 10 g/L to about 40 g/L. As in conventional practice, the reducing agent may be replenished during the reaction.

As described above, in addition to the source of nickel cations and the phosphorous containing reducing agents, the electroless plating solution can contain a pH adjusting agent, a complexing agent, a buffer, a surfactant, a stabilizer, and like additives commonly used in plating solutions. Particular pH adjusting agents that have been found to be well suited for use in the present disclosure include, but are not limited to, alkali metal hydroxide and alkaline earth hydroxides, for example, sodium hydroxide or potassium hydroxide.

In general, the pH-adjusting agent is added to the solution in order to adjust the pH of the solution. In general, the pH-adjusting agent can be added to the solution in order for the solution to have a pH of from 3.5 to 7, and in other embodiments, the pH is from 4.5 to 6.

A complexing agent refers to a substance contained in the electroless plating solution that is capable of forming a complex compound with another material in the solution. When present in the electroless plating solution of the present disclosure, the complexing agent complexes with metal ions to make the solution more stable.

Complexing agents that may be used in accordance with the present disclosure include amino acids, hydroxy acids, or their ammonium salts. Other complexing agents that may be used include pyrophosphate salts, pyrophosphoric acid, and ammonium salts of pyrophosphoric acid. Particular examples include succinic acid, malic acid, glycine, tartaric acid, citric acid, or their ammonium salts. Similar to the pH-adjusting agent, preferably a complexing agent when present in the solution does not contribute any alkali metal ions. In one particular embodiment, a citric acid-ammonium hydroxide complexing agent is present in the plating solution.

As used in the present disclosure, a buffer can be added to the electroless plating solution in order to maintain the pH of the solution within a desired range. Buffer agents that can be used in accordance with the present invention include boric acid, ammonium salts, and mixtures thereof.

In addition to the above ingredients, the electroless plating solution can further include one or more surfactants and one or more stabilizers. Any suitable surfactant can be chosen for use in the present disclosure as long as the surfactant does not adversely interfere with the plating process. In many applications, surfactants may not be needed.

The use of a stabilizer in the present disclosure is also optional. Stabilizers that can be used include, without limitation, divalent organic sulfurous compounds. Particular examples of stabilizers include thiourea and benzosulfimide.

The amount of each ingredient is present in the electroless plating solution can depend upon the particular application. For exemplary purposes only and without limiting the present disclosure, the following are relative amounts of each ingredient that can be present in the plating solution:

| Component | First Plating Bath | Second Plating Bath |
|---|---|---|
| Nickel | 6 g/L | 6 g/L |
| Phosphorous | 30 g/L | 30 g/L |

Advantageously, the coating provides improved properties relative to the prior art in terms of at least adhesion, corrosion, and ductility. The coatings can be applied to relatively inexpensive base metals to provide corrosion resistance. For example, many turbine components are formed of nickel-based alloys that are relatively expensive. The present disclosure provides a coating that can be used to replace the nickel based alloy base material with significantly less expensive carbon or low alloy steels. The thus coated substrate is expected to perform similarly to that of the nickel based alloy substrate.

It is to be noted that the terms “first,” “second,” and the like as used herein do not denote any order, quantity, or importance, but rather are used to distinguish one element from another. The terms “a” and “an” do not denote a limitation of quantity, but rather denote the presence of at least one of the referenced item. The modifier “about” used in connection with a quantity is inclusive of the stated value and has the meaning dictated by the context (e.g., includes the degree of error associated with measurement of the particular quantity). It is to be noted that all ranges disclosed within this specification are inclusive and are independently combinable. All amounts, parts, ratios and percentages used herein are by weight unless otherwise specified.

While the invention has been described with reference to the embodiments thereof, it will be understood by those skilled in the art that various changes can be made and equivalents can be substituted for elements thereof without departing from the scope of the invention. In addition, many modifications can be made to adapt a particular situation or material to the teachings of the invention without departing from the essential scope thereof. Therefore, it is intended that the invention not be limited to the particular embodiments disclosed as the best mode contemplated for carrying out this invention, but that the invention will include all embodiments falling within the scope of the appended claims.

What is claimed is:

1. An electroless plating process for forming a multilayered coating on a base metal substrate, the process comprising:
contacting a base metal substrate with a first plating bath comprising a source of nickel cations and a phosphorous containing reducing agent in amounts effective to form a first layer comprising about 4 to about 6 weight percent phosphorous with the balance being essentially nickel;
heating the first layer and the base metal substrate to a temperature greater than 500° C. to metallurgically bond the first layer to the base metal substrate; and
contacting the first layer with a second plating bath comprising a source of nickel cations and a phosphorous containing reducing agent in amounts effective to form a second layer comprising about 8 to about 12 weight percent phosphorous with the balance being essentially nickel.

2. The process of claim 1, wherein the source of nickel cations in the first and/or second plating baths comprises salts of nickel selected from the group consisting of sulfates, chloride, sulfamates, acetates and mixtures thereof.

3. The process of claim 1, wherein the source of nickel cations in the first and/or second plating baths is nickel hypophosphite.

4. The process of claim 1, wherein the phosphorous reducing agent in the first and/or second plating baths comprises a hypophosphite salt or hypophosphorous acid.

5. The process of claim 1, wherein the phosphorous reducing agent in the first and/or second plating baths comprises salts of hypophosphite selected from the group consisting of ammonium, lithium, sodium, potassium, magnesium, calcium, strontium, and mixtures thereof.

6. The process of claim 1, wherein the first and/or second plating baths further comprises a pH adjusting agent, a complexing agent, a buffer, a surfactant, or a stabilizer.

7. The process of claim 1, wherein heating the first layer and base metal substrate is in an inert atmosphere.

8. The process of claim 1, wherein the phosphorous reducing agent concentration in the first and/or second plating bath is about 10 grams per liter (g/L) to about 50 g/mols per liter.

9. The process of claim 1, further comprising surface activating the first layer subsequent to heating the first layer and prior to contacting the first layer with the second plating bath.

10. The process of claim 9, wherein surface activating comprises contacting the first layer with a protic acid.

11. The process of claim 9, wherein surface activating comprises contacting the first layer with a protic acid and ammonium bifluoride.

12. The process of claim 1, wherein the base metal substrate comprises carbon steel.

13. The process of claim 1, wherein the base metal substrate defines a turbine component.

14. The process of claim 1, wherein the base metal substrate is a carbon or low alloy steel.

15. A turbine component, comprising:
a first nickel layer metallurgical bonded to a surface of the turbine component, the first nickel layer containing about 4 to about 6 weight percent phosphorous with the balance being essentially nickel; and
a second nickel layer deposited onto the first layer, the second nickel layer containing about 8 to about 12 weight percent phosphorous with the balance being essentially nickel, wherein the first and second layers are formed by electroless plating.

16. The turbine component of claim 15, wherein the turbine component is formed of carbon steel.

17. The turbine component of claim 15, wherein the first layer has a thickness of 0.0005 to 0.005 inches and the second layer has a thickness of 0.002 to 0.010 inches.

18. A carbon or low alloy steel substrate comprising a first nickel layer metallurgical bonded to a surface of the turbine component, the first nickel layer containing about 4 to about 6 weight percent phosphorous with the balance being essentially nickel; and
a second nickel layer deposited onto the first layer, the second nickel layer containing about 8 to about 12 weight percent phosphorous with the balance being essentially nickel, wherein the first and second layers are formed by electroless plating.

19. The turbine component of claim 18, wherein the first layer has a thickness of 0.0005 to 0.005 inches and the second layer has a thickness of 0.002 to 0.010 inches.
